(19) United States
(12) Patent Application Publication
(10) Pub. No.: US 2018/0365265 A1
(43) Pub. Date: Dec. 20, 2018

(54) SYNCHRONIZATION OF A DUAL AVIONIC AND NON-AVIONIC SYSTEM

(71) Applicant: THALES, Courbevoie (FR)

(72) Inventors: Gilles BLANC, Toulouse (FR); Laurent CASTET, Toulouse (FR); Renaud ERBA, Toulouse (FR); Mathieu ORVAIN, Toulouse (FR)

(21) Appl. No.: 16/009,118

(22) Filed: Jun. 14, 2018

(30) Foreign Application Priority Data
Jun. 16, 2017 (FR) 1700650

(51) Int. Cl. G06F 17/30; B64D 43/00; B64D 45/00; G08G 5/00

(52) U.S. Cl. CPC G06F 17/30176; B64D 43/00; B64D 2045/0075; G08G 5/003; G08G 5/0004; B64D 45/00

(57) ABSTRACT

Various methods for regulating and/or for integrating avionic systems with non-avionic or open systems are described. Developments of the invention describe in particular various methods for synchronizing data via a sharing space, methods for modifying the data, human-machine interactions, steps of optimizing calculations and bandwidth, of determining alerts relating to the risks associated with calculation differences, and mechanisms for securing the secured storage space. Software and system aspects are described (EFB and FMS).

### CROSS-REFERENCE TO RELATED APPLICATIONS

This application claims priority to foreign French patent application No. FR 1700650, filed on Jun. 16, 2017, the disclosure of which is incorporated by reference in its entirety.

### FIELD OF THE INVENTION

The technical field of the invention is that of on-board systems, and in particular the technical field of avionic flight management systems, e.g. flight management systems (FMSs), or non-avionic systems, e.g. electronic flight bags (EFBs).

### BACKGROUND

The expression “avionic world” refers to certified avionic systems, which come with development guarantees.

The world known as the “non-avionic” or “open” world contrasts with, complements and interacts with this avionic world. It refers in particular to electronic flight bags or other tablets and computers, located either on the ground or on board the aircraft.

As soon as the possibility presents itself to place a computer system that processes flight elements outside the avionics (i.e. in the open world, e.g. by means of EFBs), a number of specific technical problems may arise. In particular, a technical problem relating to the communication and the updating of this system with respect to the flight management system in the avionics, and vice versa, may arise.

This updating, i.e. this interaction (bidirectional communication), between the two types of equipment may present critical security and/or safety problems, in particular with regard to the certification of the equipment and openness with respect to other systems that are interconnected with the Internet.

Additionally, the accelerated development of tools such as EFBs (for example in terms of computing capabilities, flexibility or reliability) makes the development of advanced methods for managing these interactions increasingly urgent. Communication between the two worlds must overcome a number of difficulties, while providing specific precautions, protections and guarantees.

In current systems, EFBs and their applications are generally not connected to the avionics. The crew is therefore forced to perform twice the work, since they must analyse results in the open world and manually transfer those elements which are usable and useful to the avionic systems. The addition of ESBs and their applications may consequently have an effect opposite that which is desired, which is to assist the crew by decreasing the workload.

The patent literature rarely addresses the aforementioned technical problems, and does not provide satisfactory solutions.

For example, the patent document FR3029619 entitled “MANAGEMENT SYSTEM, IN PARTICULAR A FLIGHT MANAGEMENT SYSTEM, FOR AN AIRCRAFT” discloses a management system comprising an avionics core, implementing “generic” aircraft management functionalities and the provision of services associated with at least these generic functionalities, at least one “remote functionality” (F1, F2, Fn) in an open world part (4), performing a function of interfacing between the avionics core and open world applications (AP1, AP2, APm), which need to communicate with the avionics core, ensuring homogeneity and consistency of data exchanged and guaranteeing integrity and security of data exchanges, and an exchange interface of between the avionics core and the open world functionality (F1, F2, Fn), supporting the data exchanges. This approach has limitations. In particular, the updating of data on either side is not managed, nor are considerations relating to security and safety addressed.

Certain approaches, such as that described in U.S. Pat. No. 9,583,008, provide extended FMS systems, namely for example an FMS that is distributed by design across both the avionic and open worlds, i.e. requiring an FMS system that is modified with respect to that which currently exists. This approach is limited in that it prevents the re-use of non-modified FMSs.

There is a need for methods and systems allowing controlled (e.g. secured and/or safeguarded) interactions between avionic systems and non-avionic systems.

### SUMMARY OF THE INVENTION

Various methods for regulating and/or for integrating avionic systems with non-avionic or open systems are described. Developments of the invention describe in particular various methods for synchronizing data via a sharing space, methods for modifying the data, human-machine interactions, steps of optimizing calculations and bandwidth, of determining alerts relating to the risks associated with calculation differences, and mechanisms for securing the secured storage space. Software and system aspects are described (EFB and FMS).

Advantageously, the connection or linking of the two worlds make it possible to retain or guarantee the required criteria in terms of security and aeronautical safety.

In one embodiment, a one-way communication from the avionics to the open world may be established (the data are “outsourced” from the certified systems to the open systems for processing).

In one embodiment, a two-way communication may be established (the data from the certified systems that are handled by the open systems are reinjected into the avionic systems).

This bidirectional interaction advantageously makes it possible to access numerous data sources in the open world, which substantially increase the amount of possible assistance available for managing the flight. The open world is not restricted in terms of resources (computing power, memory), and technological advancement (continual access to all of the latest developments) by virtue of fewer certification restrictions. Lastly, the usability of the human-machine interfaces of the open world is generally superior (e.g. accessible, robust, unambiguous, etc.) to the user interfaces currently used in avionics (at the very least they correspond to the general practices in mass-market computing).

Advantageously, the methods and systems according to the invention make it possible to “export” a large number of avionic functions to the open world and then to reimport the results or the manipulated and enriched data into the avionics.

In one embodiment, the import or the reimport of data, of data on data (metadata), of functions or of programs (data modifying data) may be verified, controlled or modified by the pilot (open-loop). The communication or synchronization is then “asymmetric”, meaning that the data of the mission managed in the avionics may not be replaced without the consent of the pilot.

In other embodiments (of closed loop type), the interactions between open world and avionics are performed in an integrated manner (e.g. they are safeguarded and/or secured).

Advantageously, certain embodiments allow a transparent communication to be conducted between both worlds, while safeguarding the avionic world from negative effects that might be brought about by communication with the open world. In one embodiment, the pilot does not intervene in the interaction (for example the synchronization) between the two types of system except for security-related operations.

Advantageously, in conjunction with the application of modern and up-gradable tools from the open world, the methods and systems according to the invention allow quantitative and/or qualitative improvements to the flight (e.g. in terms of performance, operating costs e.g. fuel consumption, predictability and reliability of the mission), a decreased workload for the pilot and hence better management of the cognitive load of the pilot, along with positive effects in terms of aeronautical safety and security.

According to one advantageous embodiment, the human-machine interface deployed in the cockpit comprises a page and/or command that is dedicated to verifying and/or accepting and/or modifying data from the open, non-avionic world in the management of the mission managed in the avionics.

Advantageously, the invention may be implemented within modern aircraft comprising the latest or next-generation flight management systems FMS. These flight management systems FMS, for example open-capacity FMSs, provide communication links with non-avionic systems by default. These communication links may be used by the invention. Previous-generation FMSs may be addressed in various ways, in particular through existing communication links (data links or ground to air links, described in detail below).

Advantageously according to the invention, flight plan trajectories and predictions may be calculated in the open world, hence more quickly (and be done reliably).

Advantageously according to the invention, the use of a buffer storage space between the open world and the avionic world makes it possible to decrease, both/either overall and/or occasionally, the amount of data to be exchanged, and consequently makes it possible to speed up the calculations (while remaining reliable).

In one embodiment, calculation libraries produced in the open world make it possible to determine the missing parts (data, functions, calculation results) for processing by the avionics. Sophisticated synchronization mechanisms may be implemented by virtue of the presence of the storage space.

In some embodiments, the synchronization of data between the two worlds may be incomplete, and may therefore result in additional work for the pilot (who must complete the synchronization). This step of manually verifying, completing or modifying the synchronization is detectable since it is visible on the screen.

In some advantageous embodiments, patterns, schemes or templates for data exchanges may be used and may optimize the bandwidth (freeing up bandwidth on the side of the avionic network, which may be limited).

In some advantageous embodiments, data compression techniques may be used to further minimize the size of the data synchronized over the avionic network.

Advantageously according to the invention, the ambit of the avionic functions (functional ambit) may be extended by the functions from the open world.

Advantageously according to the invention, the synchronization between the two types of system may be controlled and/or optimized by minimizing the risks relating to aeronautical safety and/or security.

Advantageously according to the invention, the data from the non-avionic world (which are potentially rich, e.g. diverse and varied) may be adapted (e.g. detected, formatted, modified, selected) then taken into account in the avionic domain. This adaption may also be contextual, i.e. performed according to the flight context (e.g. flight phase, flight event, operational objective or constraint, etc.).

Advantageously, the embodiments of the invention allow a synchronization between two types of systems (associated with different safety and/or security features). The communications may be of client/server type. In one embodiment, the synchronization may be qualified as asymmetric, favouring the integrity and the verification of the data from the avionic world.

Advantageously, the (cognitive) load of the pilot is decreased or minimized. Any action on either side (avionic side versus non-avionic side) has to be performed only in one place.

Advantageously, the secure and/or reliable storage space makes it possible to validate the data and to control/validate what is injected into the operational mission of the avionic world.

### BRIEF DESCRIPTION OF THE DRAWINGS

Other features and advantages of the invention will become apparent with the aid of the following description and the figures of the appended drawings, in which:

FIG. 1 illustrates the overall technical environment of the invention;

FIG. 2 schematically illustrates, in a general manner, the integration or the interactions between the one or more avionic and non-avionic systems 122;

FIG. 3 illustrates a specific control mode according to one advantageous embodiment of the invention;

FIG. 4 illustrates other examples of embodiments of the invention;

FIG. 5 illustrates examples of steps of the method according to one embodiment of the invention.

### DETAILED DESCRIPTION

An aircraft in the sense of the invention is a transport means capable of moving in the earth's atmosphere. For example, an aircraft may be an aeroplane or a helicopter (or even a drone). By extension, the embodiments of the invention are applicable to any type of ground, sea, air or space (optimization for orbital trajectories) transport.

The invention describes various interactions between one or more avionic systems and one or more non-avionic systems. The two types of systems are technical systems. Avionic systems are systems that meet particular, in particular technical, needs, such as those stipulated by the aeronautical regulations.

An “avionic system” (or “system of avionic type”) is a system having specific technical features in comparison with a “non-avionic” system (or “system of non-avionic type” or “open world type”), these technical features being certified administratively by a trusted authority (in this case the aeronautical regulator). Technically, delegations of authorities may in the future allow technical management of this administrative management (e.g. cryptoledgers).

With regard to the distinctive technical features of an avionic system, a system—generally, i.e avionic or non-avionic—may have or be associated with a predefined failure rate (from a predefined failure rate range), a failure rate comprising or determining a predefined execution error rate. In one embodiment, the failure rate of an avionic system is lower than the failure rate of a non-avionic system. In one embodiment, the failure rate of an avionic system is significantly or substantially lower than that of a non-avionic system.

An avionic system denotes a reliable system (or a system with guaranteed reliability). It is a system the failure of which has consequences that exceed the accepted or acceptable and therefore critical limits. A failure may be characterized by the loss of the function under consideration, or by the production of erroneous data, with or without detection of an error. Depending on the level of criticality of the critical consequences, the probability of occurrence must be keep below a threshold of acceptability. Thus, the more critical the consequence, the lower the acceptable probability of occurrence. For example, in aeronautics, a catastrophic event (multiple deaths) will have to have a probability of occurrence of less than 10̂-9 per flight hour, while a major incident (reduction of the safety margins and of the operational capabilities, discomfort or minor injuries) will have to have a probability of occurrence of less than 10̂-5 per flight hour. To meet these objectives, the architecture of the (reliable) avionic system, and also the design of each component, guarantee this probability of occurrence through guarantees of fault rate for each equipment item (physical faults) and verification levels (test functional and structural coverage) of the software.

These demands require a significant design and verification effort, and impose a limitation on the complexity of the processing operations that are implemented.

On the other hand, the failure of an unreliable system, or a system with non-guaranteed reliability (non-avionic system), has consequences that are deemed to be tolerable, non-critical, or even not to have a significant operational impact. The demands on the architecture, the physical components or the software processing operations are therefore lower, and permit more complex processing operations and development and verification efforts that are lower in comparison with a reliable system.

In order to use, during in-flight operations, data originating from an unreliable computer, on account of the fact that the reliability of the data is not guaranteed (or guaranteed with an error rate lower than the demands of the reliable system), it is advantageous to use the method according to the invention. The steps of the method make it possible in particular to ensure that no erroneous item of data is used operationally by the reliable system. The steps may comprise verification by the human operator, following manual entry or automatic transmission, or else various means for verifying the transmitted data. In some embodiments, it is also possible to have steps of computing or of verifying the coherency of the data from the non-avionic system performed by the avionic system world (for example, it may be verified that a path is constructed with known points and that it is able to be flown). The failure of a system may be ascertained deterministically, but also probabilistically.

In one embodiment, an additional comprehensiveness criterion makes it possible to qualify the criterion of the failure rate. This comprehensiveness criterion denotes the coverage of the tests (excitations, challenges not necessarily having a known response) and/or verifications (e.g. comparison of the produced response with the one that is known and expected) that have been performed beforehand on the avionic system or non-avionic system in the determination of the failure rate. In one embodiment, the comprehensiveness of the tests and/or verifications performed is greater in an avionic system in comparison with a non-avionic system.

In one embodiment, in addition to the overall failure rate of the avionic system or non-avionic system, the failure rates specific to the components of the avionic system or non-avionic system may be taken into account, as well as the propagation of the failures.

Various embodiments of the invention describe various types of exchanges (e.g. functional data and exchange dynamics), various types of protection (e.g. security mechanisms, dedicated spaces, etc.) and various examples of synchronization mechanisms that may be implemented so that the two worlds are as closely synchronized as possible. In one embodiment, a main reference is retained in the avionics.

The term “consult” refers to data or calculations arising from the avionics. The term “modify” generally refers to a datum provided by the open world in its “sandbox”. The term “inject” refers to an exchange from the open world or from its “sandbox” to the mission data generated by the avionic system.

The synchronization of data concerns all types of data (flight plan data, but also data from the navigation database, aeroplane states (for example flight phase) and commands (example :insert waypoint)/Various types of objects are calculated, communicated and compared, on both sides (avionics versus non-avionics). For the consultation part, these objects comprise in particular (permanent and user) navigation databases, magnetic variation databases, static features of the aircraft, elements from the database on the performance of the aircraft, the states of the avionic system, the flight plan data, the trajectory data and the prediction data. For the modification part, the objects comprise in particular the user navigation databases and the flight plan data. For the injection part, the objects comprise in particular the user navigation databases and the flight plan data.

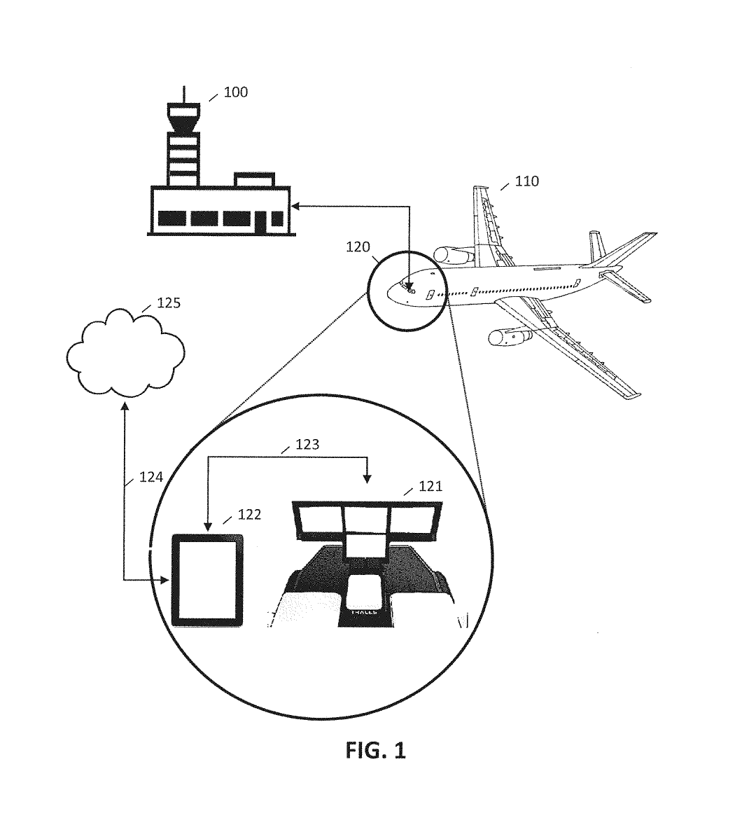

FIG. 1 illustrates the overall technical environment of the invention.

An aircraft 110 is a transport means capable of moving in the earth's atmosphere. For example, an aircraft may be an aeroplane or a helicopter (or even a drone). The aircraft comprises a piloting cabin or a cockpit 120. Inside the cockpit is piloting equipment 121 (termed avionic equipment, which is certified by the aeronautical regulator) and optional equipment (termed non-avionic or “open world”).

The avionic equipment 121 (hereinafter “the avionics”) comprises for example one or more on-board computers (computing, memory and data storage means) including a flight management system (FMS in acronym form), human-machine interface means, such as display means (e.g. screens incorporated into the avionic equipment) and/or data entry means (e.g. keyboards, buttons, cursors, rotary controllers, etc.), communication or haptic feedback means. By extension, the avionic systems may comprise remotely accessible systems, for example to air traffic control 100 and/or to an operational centre, which may be in (two-way) communication via ground-air links. Moreover, the air traffic control 1001 and/or operational centre systems may access (e.g. receive, collect, select, come across, determine) open data sources (e.g. non-regulatory weather data), for example accessible from the Internet and the coverage and depth of which covers the entire flight of the aircraft.

Non-avionic systems 122 denote on-board devices or devices on the ground that may for example comprise one or more computerized tablets or EFBs (“electronic flight bags”) that are portable or integrated into the cockpit, viewing means (e.g. additional screens, smart glasses, head-up displays, projectors, holographic systems, virtual-reality and/or augmented-reality headsets termed “wearable computers” or “head-mounted displays”, etc.), and also interaction means (e.g. laser-projection keyboards, fold-out components, roll-out components; haptic, force feedback, mechanical, pneumatic and electrical systems; dictation or voice recognition means with noise suppression, etc.).

A non-avionic EFB is sometimes referred to or described as an “open (world)” device, as opposed to “avionic” devices (which are certified by the regulator). An EFB can interact (unidirectional or bilateral communication 123) with the avionics equipment items 121. The EFB can also be in communication 124 with external computer resources, accessible via the network (for example cloud computing 125). In particular, the computations may be performed locally on the EFB or partially or entirely in the computation means accessible via or through or in the network.

The on-board equipment 121 is generally certified and regulated, whereas the EFB 122 and the connected computing means 125 are generally not certified (or are to a lesser extent). According to the embodiments (types of integration), the architectures able to be implemented make it possible to inject flexibility and functional capabilities from the open world (e.g. via the EFB 122) while providing (controlled) safety on the part of the on-board avionics 121.

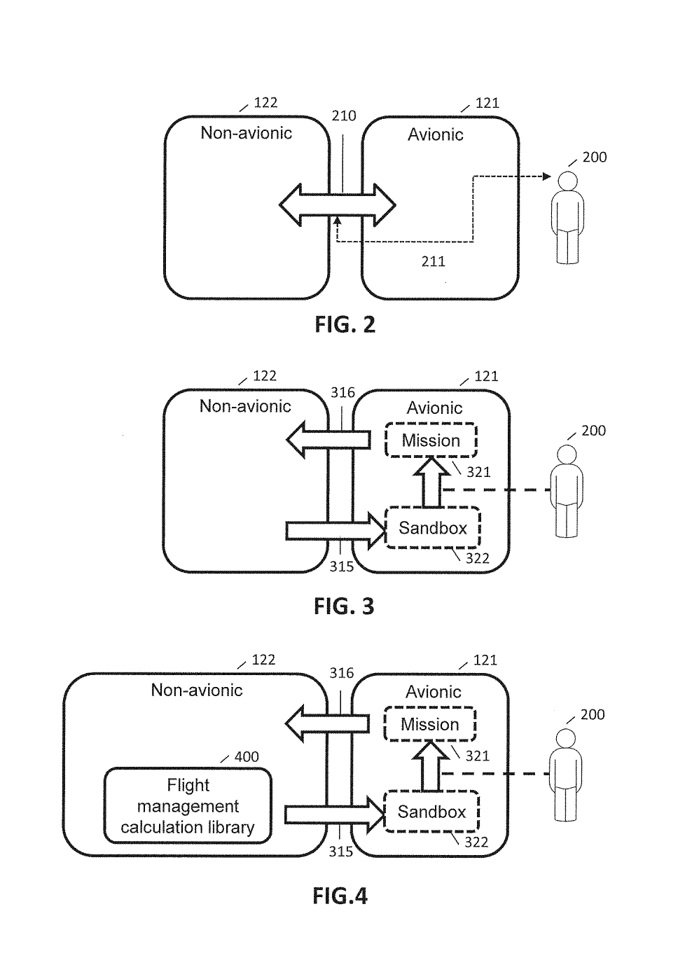

FIG. 2 schematically illustrates, in a general manner, the integration or the interactions between the one or more avionic 121 and non-avionic systems 122.

The regulation 210 of the interactions between the avionic systems 121 and non-avionic systems 122 may be de facto, i.e. via rules for managing the data exchanges, implemented on both sides. The regulation 210 may also take the form of a dedicated regulating member or entity. In certain embodiments, the pilot 200 may control 211 (modify, influence, regulate, stop, prime, initiate, etc.; either directly or indirectly) the exchanges between the systems 121 and 122 (e.g. in terms of nature, volume, quality, etc.). The pilot may in particular use one or more human-machine interfaces. The regulating rules may in particular result from the intervention of the human and/or of the machine (hence in particular result from joint human-machine decisions).

Generally, the methods of communication between the two types of system, avionic system and non-avionic system, cover different aspects or parameters:

a) directionality; the communication between the two types of system (e.g. data flow, message passing, etc.) may be unidirectional or bidirectional. This directionality property may be static (does not vary over time) but may also develop over time (in predefined intervals of time and/or depending on predefined events), for example depending on the flight context or phase. For example, the communication may be bidirectional when the plane is on the ground at its boarding gate, and unidirectional once it starts moving. In this example, when the plane is on the ground, any modification proposed by the non-avionic system to the avionic system may be verified and, if it were to be erroneous, it would not reduce the safety in so far as this modification could still be modified and corrected. Once movement starts and in flight, the communication takes place first of all only from the avionic system to the non-avionic system, any item of data produced by the non-avionic system not being able to be transferred automatically to the avionic system.

b) form (e.g. data format, protocol type, translation/bridging, etc.). For example, a WiFi or wired Ethernet protocol may be best optimized on the ground (given the large volume that may be exchanged on the ground to initialize the mission), while a more secure but lower-throughput protocol may be preferable in flight, given the on-board communications architectures (AEEC ARINC 653) that may require the bandwidth and the integrity to be guaranteed for all of the critical computers and may therefore limit de facto the throughput and the type of data exchanged with the non-avionic system.

c) background (quality e.g. nature of the communicated objects, e.g flight plan points or 3D path, etc.; data regarding the data, i.e. metadata; raw or static data; executable data, i.e. programs). A non-avionic system, in addition to the flight plans, is able to receive a large amount of rich data only part of which will be utilized by the avionic system: aeronautical maps, high-resolution geographical maps, complete weather maps. The avionic system may use a sub-part of the data, which are filtered for the purposes thereof (for example filtering along the flight plan, filtering of the resolution suitable for its memory limitations, for its limits in terms of computational power, etc.).

d) amount (or volumes). A non-avionic system may use rich data (there is no actual limitation in terms of the processor, memory and storage; powerful multicore processors may be used, while the avionic system computers have a hardware architecture that is very robust but much more limited in order to guarantee the testability of the required performance, for example with properties of resistance to high-energy particle events during the flight (SEU, NSEU), of resistance to vibrations or to extreme temperatures. Avionic system computers generally have significantly less power than non-avionic computers.

e) privileges or priorities (e.g overall priorities may be allocated; for example the “master” avionic system will be associated with a priority higher at all times than the “slave” non-avionic system; “administrator” or “read/write” privileges will be allocated to the various parts for example in terms of access, reading from and/or writing to one or the other type of system).

The regulation of the data exchanges may govern each of these aspects differently and combine them in a particular way. According to the embodiments, (scalable or non-scalable) master/slave systems or (scalable or non-scalable) peer-to-peer networks will be obtained, comprising numerous and varied types of feedback (e.g. feedforward, etc.).

The reference to human-machine interfaces refers to a varied group of devices. The display devices may comprise or implement one or more sophisticated devices, such as virtual-reality headsets and/or augmented-reality glasses (e.g. “head-mounted display”, “wearable computer”, “glasses” or a headset-mounted display) and/or projection devices (that are e.g. holographic). A virtual-reality headset worn by the pilot may be opaque or semi-transparent or be able to be configured in terms of transparency. The display may be a “head-up” display. The headset may comprise one or more computing and communication, projection, audio capture, projection and/or video capture devices (for example for capturing or “scraping” accessible data in an analogue fashion from the cockpit or the piloting cabin of the aircraft). The cockpit of the helicopter may also comprise voice command devices. The on-board instruments may advantageously allow the pilot to view his or her flight plan or his or her path in 3D, and notably the various waypoints according to the invention. The pilot may for example view—for example by superimposing these alternative routes onto his or her real surroundings—the various approaches for the target platform, the points where the path is able to be joined when said points are still possible (changing from one type of approach to another). The safety distance could be viewed via graphic envelopes (cones, volume polyhedra, virtual walls, virtual corridors, etc.), along with local parameters (for example wind speed, actual measurements by laser anemometry of local winds or turbulence, or computer simulations of the latter.

Lastly, haptic feedback devices incorporated into the system for implementing the invention may enrich the guidance/piloting (specific vibrations when effectively crossing a waypoint, etc.).

With regard to the display, the information may be displayed in one or more virtual-reality and/or augmented-reality headsets. The information may therefore be entirely virtual (displayed in an individual headset), entirely real (for example projected onto the flat surfaces available in the real environment of the cockpit of the helicopter) or a combination of the two (partly a virtual display superimposed on or merged with the reality and partly a real display via projectors). The display may also be characterized by the application of predefined position rules and display rules. For example, the human-machine interfaces (or the information) may be “distributed” (divided into separate portions, which are possibly partially redundant, and then distributed) between the various virtual or real screens.

In one embodiment, the avionic system and non-avionic system use entirely separate (e.g. mutually exclusive) physical hardware media (processor, memory, etc.). For example, the avionic system and non-avionic system interact via data links (of logic nature).

In one embodiment, the functions are distributed between the avionic and non-avionic systems. In one embodiment, a secure communication member may form the link between the two types of systems. The data transport may for example be of IP or secure IP type. In this embodiment, the avionic system and non-avionic system exchange commands and data, but the completeness of the data in both worlds is ensured by independent computing in each system.

A non-avionic system may perform significantly more calculations by virtue of resources in terms of memory and CPU that are of a higher order with respect to those of the avionic system. A non-avionic system may therefore perform calculations dichotomously until approaching an optimal solution, which will be refined and confirmed by the avionic system world while optimally using the substantially less abundant resources in this type of system. Furthermore, the physical hardware media of the non-avionic systems advance much more quickly than the avionic systems.

In one embodiment, the avionic system and non-avionic system share part of the hardware resources (processor, memory, etc.). For example, at least one memory unit can be accessed both by the avionic system and by the nonavionic system. In one embodiment, part of the resources of the avionic system may be dedicated to the non-avionic system so that the avionic system can calculate and verify computing assumptions generated/formed in the non-avionic system world. The properties of the avionic system may thus be exported into the non-avionic system. Although available to the non-avionic system, these avionic system resources may be protected and their use cannot spread, to the rest of the avionic system, errors which originated in the requests and data from the non-avionic system world. It is therefore advantageous to make use of the avionic resources sparingly.

In one embodiment, an avionic system and a non-avionic system share all of the hardware resources (processor, memory, etc.). Two particular embodiments may be described. For example, an avionic system FMS is entirely virtualized on a host machine, which hosts both an avionic system and a non-avionic system. In one embodiment, the hardware platform of the non-avionic system is promoted to a certification level equal to that of the avionic system. From an administrative point of view, this constraint is expensive in terms of qualification, but advantageously leads to an optimization in terms of data transfer from one world to the other. In one embodiment, a non-avionic FMS is entirely virtualized on the hardware medium that (mainly) hosts the avionic system. This embodiment is limited due to the lack of upgradability and of resources of the hardware media of the avionic system but the regulatory constraints may be satisfactory.

In one embodiment, the avionic system and non-avionic system are linked by exclusively wired connections, i.e. excluding any interceptable wireless communication. The wired connection of the systems may make security-compromising attacks more difficult (e.g. malicious compromising attacks, interceptions or injections made possible in wireless embodiments).

In one embodiment, the avionic systems and the non-avionic systems are linked by wireless connections, but these connections are secured by sufficient encryption (complex keys which are refreshed more frequently than the minimum cryptanalysis time, the latter being for example evaluated according to the means available to an aircraft passenger).

In particular, the regulation 210 (either de facto or using a regulating member) between the avionic system and non-avionic system—as a component critical to the interface of the two types of system—may be subject to dedicated security measures (for example independently of the other systems). The security mechanisms may comprise one or more of the mechanisms comprising encryption of the data (for example with asymmetric keys), authentication mechanisms (that are for example biometric), self-monitoring mechanisms (e.g. state machine, “watchdog”), anti-intrusion mechanisms (e.g. IDS), mechanisms for continuously verifying the integrity of the data manipulated in the gateway server, sharing of a prior secret, etc.

In one embodiment, the regulation between avionic system and non-avionic system may be agreed (or recognized or accepted or authorized) by the non-avionic systems on the one hand and the avionic systems on the other hand, intermittently, regularly or on demand.

The security mechanisms may comprise one or more mechanisms and/or steps selected from the group comprising a step of checking the integrity of all or part of the data and/or results (e.g. initial, intermediate, final results); a step of authenticating a machine and/or the pilot (e.g. PKI, biometrics, etc.); a step of encrypting all or part of the data; a step of counting the communications or the data or the types of data exchanged between the avionic system and non-avionic system, a step of classing protocol behaviours as normal or abnormal, etc.

The integrity check may comprise a CRC or checksum verification step. Checking the integrity of the data may comprise the use of hash chains (e.g. of blockchain type, for example to guarantee the integrity of the data and/or the history of flight plan revisions. The data and the revisions thereof may be accessed at any time and by any party (permissionless ledgers) or by prior registration (permissioned ledgers).

The encryption may be symmetric (private key encryption). The encryption may be asymmetric (private key and public key encryption); for example the avionic system may keep its private key secret for decrypting the encrypted communications by means of its public key via the non-avionic systems.

Counting the exchanges refers to the quantitative control of the exchanges, which may be differentiated by types of data. For example, counters may be put in place to make it possible to constrain (limit, ceiling, brake, slow, etc., in a binary, affine or exponential manner,) the number of data imports and/or exports between the avionic system and non-avionic system.

The communications between the avionic system and non-avionic system may be regulated in an open loop, i.e. requiring human validation, which may entail a graphic (visual) rendering for decision-making.

The authentication may comprise a plurality of mechanisms in combination (e.g. biometric, card-based, code-based, authentication, or syndication by logic test e.g. a Turing test of Captcha type so as to be sure of the human origin of the decision to inject data into the avionic system).

FIG. 3 illustrates a specific control mode according to one advantageous embodiment of the invention.

The data from the open world are communicated 316 to the avionics and are received and stored in a “sandbox” 322, the content of which can be accessed by the pilot 200 who, if necessary, validates or authorises, potentially after modification, the injection of the data into the flight management system FMS or mission management system 321. The avionics accurately calculates the trajectory and optionally a feedback loop 316 may communicate the calculated data to the non-avionic system 122.

In greater detail, the arrows 315 and 316 symbolically represent data communications, for example via requests for functions or for services. The data are received (and isolated) in the sandbox 322 then communicated in a secure manner to the avionic mission module. The communication or transfer of the data may optionally be adjusted or authorized by the pilot 200. Specifically, the pilot may validate the synchronized data during injection into the operational mission. After processing by the avionic system 122, data are returned 316 to the non-avionic system.

The sandbox 322 may be implemented by hardware in various ways. The example of FIG. 3 places this secure storage space in the avionics, but in other embodiments, it may be implemented in other physical and/or software locations (e.g. secure USB stick, logical partition, dedicated EFB, cloud-based server, etc.), the security and integrity of the data being ensured by one or more mechanisms described below.

In one embodiment, the sandbox 322 is a passive storage space. It inserts (in queued form) the elements calculated by the non-avionic systems and transmits them in fine to the avionic systems. The gateway server then serves as a buffer memory or buffer between the two types of system. In one embodiment, the sandbox 322 may order the queue, for example depending on the priority associated with the various objects placed in the queue, depending on the flight context and/or the use of avionic resources that may be, as the case may be, underburdened or overburdened, etc.

In one embodiment, the sandbox 322 between avionic system and nonavionic system is an active storage space, i.e. adds logic processing operations to the received data. The sandbox 322 may perform one or more of the following actions: perform its own verifications with regard to the conformity of a route with respect to the avionic criteria, receive instructions from a third-party system, etc. In one embodiment, the sandbox 322 may verify the conformity between the trajectory calculated in the avionics and the trajectory originating from the calculation outside of the avionics.

In one embodiment illustrated in FIG. 3, the dual hierarchized (master-slave) system comprises a master avionic system and a slave non-avionic system. In this context, multiple interaction methods (e.g. synchronization mechanisms) are described.

In one embodiment, there is a partial exchange of data and recalculation on both sides to reproduce a functionally equivalent situation. In one embodiment, the master system has particular data (for example actual position of the aero-plane) which allow the result to be dictated. Verifying the integrity or the reliability of the data produced is possible by virtue of an assistant showing the differences between the two calculations. In one embodiment this verification is performed by a human (via a human-machine interface). In one embodiment this verification is performed by the machine (via a system of logic rules manipulating quantified facts). In one embodiment, the verification is performed jointly by human and machine (e.g. possibly weighted, the final say possibly given to the pilot, etc.).

In one embodiment, there is a complete exchange of data and aircraft states. The data from the slave or slaved part are entirely replaced with the data by the master part. The avionic system imposes its states and its data.

In one embodiment complimentary exchanges of data with each part (which may take on a role of master for certain types of data or manipulated objects) take place, the other remaining data being recalculated locally by each part. In one embodiment, each part may in fact be specialized, i.e. take on the role of master for some data and the role of slave for other data. Some data may be provided by one part or by the other (for example, data entered via the human-machine interfaces).

In one embodiment, the integration between the systems 121 and systems 122 may be performed discretely, i.e. determined according to predefined time intervals. In one embodiment, each system may receive the same data as input, recalculate all of the states, time synchronization points that are predefined (e.g. periodic or intermittent) and/or performed on demand and/or according to the occurrence of a predefined event may lead to verifying that the output states of each system remain within a given range (i.e. that the systems do not diverge). If the systems diverge, the master system may impose its state to resynchronize the slave system.

In one embodiment, the integration between systems 121 and 122 may be performed continuously or near continuously, e.g. the results of intermediate calculations are compared (rather than the final results, as in the embodiments described above). Advantageously, a potential divergence of the systems will be detected sooner than in the case of occasional integration.

In one embodiment the roles between systems 121 and 122 are predefined, asymmetric and generally invariant over time. In one embodiment, the allocation of the roles may be variable (entirely or partly, e.g. reactively variable, according to multiple parameters, etc.).

In one embodiment, one or more voting mechanisms may allow on-demand denial or rejection of the projected or current regulation, which would be considered to be corrupted or risky (for example if at least one of the avionic systems determines it to be such, etc.).

FIG. 4 illustrates other examples of embodiments of the invention.

In one embodiment, a non-avionic type system may comprise a flight management calculation library 400. The flight management calculation library 400 refers to a software code run on hardware. This logic block, according to the embodiments, may perform path prediction computations that are identical, or functionally equivalent, to those performed in the avionic system. The performed calculations reproduce, as closely as possible, the processing operations such as they would be applied by the avionic system (the software code is structurally identical, potentially recompiled, or it is functionally equivalent). This calculation module may also implement various optimization steps (e.g. heuristics, A-star algorithms, genetic algorithms, potential field-based algorithms, etc.). The block 233 may also translate or transcribe the output data into a format that is functionally equivalent to that handled by the avionic system 1213.

In one embodiment, the avionic FMS 121 has interfaces provided for communication with third-party systems (“open capacity” FMS). If necessary, the flight management calculation may be made available by the NG flight management system FMS and its open capacity.

In one embodiment, the calculation module 400 may perform search and optimization steps, avionic en-route transcription steps (adaption, translation, etc.), which may lead to trajectory predictions and calculations. Lastly, the paths that are produced are manipulated in the comparator (possibly secure comparator 231).

In terms of hardware, the computer 233 may be implemented on a tablet or laptop (or on any other computing means external to the avionics, for example via remote access) allowing alternative routes to be determined (e.g. sought, evaluated, selected, etc.).

In one embodiment, the exchanges between the systems 121 and 122 (these exchanges may be referred to by the term “synchronization”) take place in the following manner: the avionics 121 performs calculations and sends them 316 to the open system 122 or 400, which enlists redundant, but also potentially complementary, calculations (for example by cross-referencing the information with data of non-avionic origin of broader scope); the open system 122 or 400 may also augment the calculations, e.g. perform the analysis of a large number of variants of the central calculation, or at least of the initial calculation performed by the avionics, in parallel. The one or more open systems communicate 315 the result of the, for example optimized, calculations to the sandbox 322, the architecture of which is designed to serve as a buffer before the actual reinjection of the data. The sandbox may be used as a security, decontamination or quarantine airlock (from a passive buffer role it may be developed into a contained space incorporating a battery of logic tests, the integrity and/or conformity verification may in particular be compartmentalized, e.g. performed independently of the other entities present in the architecture, etc.).

In one open-loop embodiment, the pilot checks 211 the data and may modify them, which results in the synchronization between the two types of systems being “completed”.

In one closed-loop embodiment, the pilot does not intervene since his or her decision criteria have been modelled and quantified via logic rules and objective or objectivizable facts.

In one semi-open embodiment, the feedback loops are generally closed but the pilot retains the possibility to intervene on demand (for example, a visualization of the data streams, both avionic and modified by the open world, may be maintained, leaving the pilot with the opportunity to intervene as an overseer when he or she desires).

Once validated (whether modified or not by human and/or machine), the data are reinjected 321 into the avionics 121.

In one embodiment, the data or parts of data (i.e. the modifications) are tagged as such. Stated otherwise, in some embodiments, data on data (or metadata) are produced and retained within the avionics, which advantageously allows a certain degree of traceability of the (introduced modifications—subsequently measured consequences) pairs.

In some embodiments, since tasks of increasingly higher level are allocated to the pilot (the routine tasks being automated), various mechanisms, for example security, test, verification or visualization mechanisms, performed locally on predefined aspects (checkpoints, divergences, etc.) may allow the overall integration to be supervised. Aspects of the regulation may in particular be variable and in particular be programmed to depend on the flight phases. Certain critical flight phases in fact require active and complete control on the part of the pilot whereas others require less sustained attention.

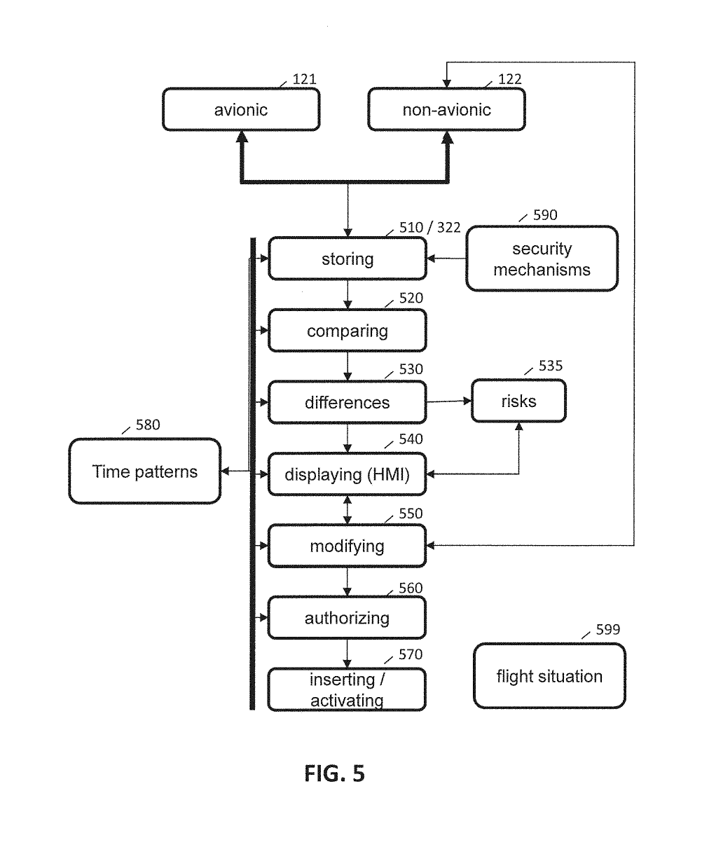

FIG. 5 illustrates examples of steps of the method according to one embodiment of the invention.

In one embodiment, a method for managing flight data of an aircraft is described, which method is implemented in a system comprising an avionic system 121 and a non-avionic system 122, the method comprising the steps of: determining flight data in the non-avionic system 122; storing 510 said data in a storage space; determining corresponding flight data in the avionic system 121; comparing 520 the data determined by the avionic system and by the non-avionic system according to a predefined time pattern 580.

In one embodiment, the system according to the invention comprises an avionic system and a non-avionic system. The data exchanges (the “synchronization”) take place via exchanges of data.

In one embodiment, the avionic and non-avionic systems calculate the various avionic objects (for example an alternative trajectory or path, a reroute, etc.) on each side.

These calculations may entirely or partly overlap. Generally non-avionic calculations, arising from more optimized calculations and in particular using data of broader scope, may supplement the avionic calculations.

The data calculated on each side are compared 520 within a shared storage space. The term “corresponding” means that the same objects (paths, trajectories, flight parameters, etc.) are handled on each side.

The temporary storage space 322 may be a “private” space within the avionics and dedicated to the open world. In one embodiment, the temporary storage space is a “sandbox”, which allows the open world to be able to propose, modify and calculate data for the avionic world before they are injected into the mission managed by the avionics.

In one embodiment, comparing mechanisms 520 monitor the changes on each side. In some embodiments, discrepancies may in fact remain between the calculations performed on the open world side and on the avionic side. For example, the pilot might incorrectly believe that the aircraft is being guided on a modified flight path, whereas the corresponding modification has been made only on the open world side (and is perhaps lost to the pilot).

The comparisons may be made continuously, intermittently, at regular intervals or otherwise (e.g. according to events unfolding over the course of the flight) according to the time patterns 580.

In one embodiment, the avionic storage space is implemented in the avionic system. In this embodiment, the storage space is shared and hence can be accessed by the two types of systems; however it advantageously retains the reliability characteristics (physical fault rate and the logic verification level) associated with avionic systems (the degree of reliability of which is higher than that associated with a non-avionic system).

In one embodiment, the avionic storage space is implemented in a reliable non-avionic system, the physical fault rate and the logic verification of which are respectively lower and higher than those of a non-avionic type system. In one embodiment, an intermediate system may be used. If an existing flight management system FMS cannot be modified to incorporate the storage space, a reliable system may be used.

In one embodiment, the method further comprises the steps of detecting the presence of predefined critical data in the data determined by the avionic system and by the non-avionic system; comparing these critical data; displaying the critical data that differ via the human machine interface.

“Objects”, i.e. one or more “critical” (or “essential”) data, may specifically be predefined.

A critical (or essential) object may be associated with a systemic risk. A risk qualified as “systemic” implies that there is a probability (not only a nonzero probability, i.e. a non-negligible probability with respect to predefined acceptable thresholds) of major malfunctions, affecting aeronautical security and/or safety. A local event, even one of limited nature, may have catastrophic overall consequences. Certain objects may lead, either directly or risk leading indirectly, to “systemic” risks.

In mathematics, the value taken by a function at a critical point is referred to as a critical value. A critical point is used as an intermediary in the search for the extremum of a function. In computer science, a critical system is a system in which a failure may have severe consequences, including significant hardware failure or damage (with an impact on the safety of the flight of the aircraft). The concept of “criticality” also introduces a quantification of this critical character by associating various “stages”, “steps”, “attributes” or “levels” therewith.

In one embodiment, an object may therefore be associated with metadata representing the local and/or overall risk level, which may be quantified or discretized.

The risks may be thresholded (the criticality of an object may be determined in terms of exceedance of a threshold or a range of predefined thresholds).

These critical or essential objects may be determined in various ways.

In one (bottom-up) embodiment, the history of the differences, modifications and consequences is recorded and data analyses, performed manually and hence predefined “arbitrarily” and/or performed by learning (e.g. supervised, unsupervised, big data, statistical approaches, etc.) determine these objects, which it is possible to qualify as “critical” or “essential”.

In one (top-down) embodiment, said objects are determined a priori. Technical expertise, piloting experience or an analysis of the risks may specifically allow particularly risky objects to be identified.

In one embodiment, the critical data are determined in real time. In one embodiment, the essential and/or critical feature is calculated de facto: the mean and long-term divergences are determined and compared. For example a modification to the data relating to an alternative airport in an adverse weather situation in conjunction with a limited fuel level may lead to an assessment that the long-term consequences of this modification exceed an acceptable threshold.

In one embodiment, the data considered to be critical may be different according to the flight phase (for example a datum may be critical at a given moment and not another).

In one embodiment, the essential or critical feature is determined due to the presence of intrusive data. The concept of “intrusion” refers to a manifestation of a desire to access reserved or protected software or hardware resources. Some avionic resources are more essential or more sensitive than others. Modifications that call upon these resources may be qualified as intrusive. The protected resources may vary with time (time driven) and/or with events (event driven).

In one embodiment, the determination of the presence of such critical or essential data may trigger an alert. This alert may take the form of a feedback loop with the pilot (in particular via validations via the human-machine interface, which may consist of displays in text mode, so as not to make the interfaces overly complex, to detailed presentations of eventual divergences).

In the case of a divergence (one or more differences between the critical data), the method may comprise a step of showing the pilot these differences in order to decide whether the data determined by the non-avionic system may be retained and validated.

In one embodiment, the method further comprises the step of determining risks 535 associated with the differences between the compared data. Optionally, a pilot assistant may be provided to identify the differences and/or the risks in the critical data (for example, the data for which the systemic effects are known, i.e. the domino effects of which may decrease aeronautical security and/or safety).

In one embodiment, the method further comprises the step of displaying 540 all or some of the differences between the compared data and/or the risks associated with the differences via a human-machine interface. The pilot may view the differences and intervene if necessary. The synchronization of the open world with the avionics, and in particular the mission space of the avionics dedicated to the pilot, may be under the manual control of the pilot (at least at first, then potentially under automatic control later on). A variety of human-machine interface devices has been previously described.

In one embodiment, the method further comprises the step of modifying 550 all or some of the determined data in the non-avionic system. The modifications may be made at any time: after the first open-world calculations and before comparison, after comparison, before the insertion of said data (for example for validation purposes), before actual activation (in the flight plan).

It is possible to add, to remove, to modify, to insert, to merge, and to replace data from the open system to the avionic system. It is possible to show the differences that will be injected. Some confirmations may be optional, others may be required (in particular according to the type of object). Regarding the synchronization from the avionics, the data may be replaced in part or entirely. The data that have been inserted may be displayed.

According to one embodiment, the predefined time pattern 580 comprises predefined time intervals, comprising instants in time and durations, for comparing and/or modifying the data.

In one embodiment, the instants in time of these exchanges and the durations of these exchanges (the frequency or the time intervals of synchronization) are such that a temporary desynchronization of the two types of systems does not operationally disrupt the pilot (typically the two systems may remain independent for a maximum duration of around five seconds). In other embodiments, the frequency of the exchanges is much higher and maximum desynchronization time is shorter than one second. In other embodiments, caching mechanisms make it possible to endure losses of exchanges over longer durations.

The data exchanges (the synchronization, in either direction) may take place automatically and periodically, automatically on change of data, or else manually, performed by the pilot. The synchronization mode (automatic or manual) may be different in each direction. In one embodiment, the automatic mode may be favoured (from the avionics to the open world) and the manual mode may be favoured from the open world to the avionics.

The proposed type of exchange pattern may in particular be optimized to minimize the exchanges over the network. Similarly, data compression steps may allow the size of the data synchronized over the avionic network to be minimized.

In one embodiment, the method further comprises the step of receiving an authorization 560 to insert and/or to activate 570 the potentially modified data determined by the non-avionic system into/in the avionics system. In one embodiment, the confirmation or authorization may come from the pilot. In one embodiment, the confirmation may come from a third party system, for example a link with a human and/or machine (ATC crew, etc.). Lastly, the transfer of data from this open-world dedicated space to the avionic domain is authorized or otherwise by the pilot or co-pilot.

The pilot may be assisted in this request to authorize the transfer by an accentuation of the critical data that have changed and/or a verification that the proposed flight can be flown by the aircraft.

In one embodiment, the storage space is secured by one or more mechanisms 590 selected from the mechanisms comprising encryption of the data, checking the integrity of the data or authentication mechanisms.

In one embodiment, one or more steps are triggered or are dependent on the flight context 599.

One or more steps of the method (synchronization type, nature of the synchronized elements, synchronization times, etc.) may in particular be dependent on the flight situation of the aircraft.

The flight context at a given moment incorporates all of the actions taken by the pilots (and notably the effective piloting instructions) and the influence of the external environment on the aircraft. A “flight context” for example comprises a situation out of the predefined or pre-categorized situations associated with data such as the position, the flight phase, the waypoints, the current procedure (and others). For example, the aircraft can be in approach phase for landing, in take-off phase, in cruising phase but also in level ascending, level descending, etc. (a variety of situations can be predefined). Moreover, the current “flight context” may be associated with a multitude of attributes or of descriptive parameters (current weather state, state of the traffic, status of the pilot, comprising for example a stress level as measured by sensors, etc.). A flight context may therefore also comprise data, which are for example filtered by priority and/or based on flight phase data, weather problems, avionic parameters, ATC negotiations, anomalies linked to the status of the flight, problems linked to the traffic and/or to the topology. Examples of “flight context” comprise for example contexts such as “cruising phase/no turbulence/nominal pilot stress” or indeed “landing phase/turbulence/intense pilot stress”. These contexts may be structured according to various models (e.g. hierarchized for example in a tree or according to various dependencies, including graphs). Context categories may be defined, so as to synthesize the needs in terms of human-machine interaction (e.g. minimum or maximum interaction period, minimum and maximum number of words, etc.). Specific rules may also exist in some contexts, notably emergencies or critical situations. The context categories may be static or dynamic (e.g. able to be configured).

The method may be implemented in a system comprising means for determining a flight context of the aircraft, said determination means comprising in particular logic rules, which manipulate values as measured by the physical measurement means. In other words, the means for determining the “flight context” comprise system means or “hardware” or physical/tangible means and/or logic means (e.g. logic rules that are for example predefined). For example, the physical means comprise the avionics instrumentation proper (radars, probes, etc.) which make it possible to establish factual measurements characterizing the flight. The logic rules represent all the information processing operations that make it possible to interpret (e.g. contextualize) the factual measurements. Some values may correspond to several contexts and, by correlation and/or computation and/or simulation, it is possible to discern candidate “contexts” by way of these logic rules. A variety of technologies makes it possible to implement these logic rules (formal logic, fuzzy logic, intuitionist logic, etc.).

A description is given of a system comprising means for implementing one or more of the steps of the method. In one embodiment, the avionic system comprises a flight management system FMS.

In one preferred embodiment of the invention, the avionic system is an NG (next-generation) FMS avionic system communicating via the open capacity component. This open capacity function provides the possibility to use the storage space (sandbox) according to the invention. The resources of this sandbox storage space are then limited but reserved in terms of CPU, memory space, so as not to interfere with the operational mission activity of the pilot. The open capacity function provides several types of services, according to several exchange schemes, in particular a) of request-response type, which makes it possible to consult any type of information in the mentioned domains orb) for modifying, inserting data into the storage space c) for subscribing to events to be informed of changes in the avionic world. These events may for example indicate which types of data have changed and allow the open world to transmit the request to obtain an update of the data and d) to periodically broadcast the main changes to the state of the system made in the avionic world. This broadcast is available to those who want to hear it. It is not necessary to subscribe to it. Lastly, the open capacity function provides the possibility to inject the data arriving from the open world into the operational mission after recalculation and passing through the storage space.

In one embodiment, a non-avionic system comprises an electronic flight bag EFB or a non-avionic human machine interface.

In one embodiment, the avionic system is a master system and the nonavionic system is a slave system slaved to the master system.

In some embodiments, the non-avionic system and the avionic system are equal in terms of privileges (access, read and/or write rights).

In some embodiments, the avionic system and the non-avionic system do not have equal roles in terms of privileges (access, read and/or write rights). For example, one or the other system will have higher prerogatives (e.g. according to the data and/or over time). One or the other system could have priority (either in general, or for particular functions and/or data). For example, the flight management system could be considered the “master system” while the non-avionic system could assume the role of “slave system”.

A description is given of a computer program product, said computer program comprising code instructions configured to perform one or more of the steps of the method when said program is executed on a computer.

The present invention may be implemented on the basis of hardware and/or software elements. It may be available as a computer program product on a computer-readable medium. The medium may be electronic, magnetic, optical or electromagnetic.

In one embodiment, the method is implemented by computer.

In one embodiment, the system for implementing the invention comprises a computer-readable storage medium (RAM, ROM, flash memory or another memory technology, for example a disk medium or another computer-readable non-transitory storage medium) coded with a computer program (that is to say a plurality of executable instructions) that, when it is executed on a processor or a plurality of processors, performs the functions of the embodiments described above. By way of example of hardware architecture suitable for implementing the invention, a device may include a communication bus to which a central processing unit (CPU) or microprocessor are connected, which processor may be “multicore” or “manycore”, a read-only memory (ROM) able to contain the programs necessary for implementing the invention; a random access memory (RAM) or cache memory containing registers suitable for recording variables and parameters that are created and modified during the execution of the aforementioned programs; and an I/O (“input/output”) or communication interface suitable for transmitting and for receiving data.

In the case where the invention is implanted in a reprogrammable computing machine (for example an FPGA circuit), the corresponding program (that is to say the sequence of instructions) may be stored in or on a storage medium that is removable (for example an SD card, or a mass storage means, such as a hard disk, e.g. an SSD) or that is non-removable, that is volatile or non-volatile, this storage medium being readable in part or in full by a computer or a processor. The computer-readable medium may be transportable or communicable or mobile or transmissible (i.e. via a 2G, 3G, 4G, WiFi, BLE, fibre-optic or other network).

The reference to a computer program that, when it is executed, performs any one of the previously described functions is not limited to an application program being executed on a single host computer. On the contrary, the terms computer program and software are used here in a general sense to refer to any type of computer code (for example, application software, firmware, microcode, or any other form of computer instruction, such as web services or SOA or via programming interfaces API) that may be used to program one or more processors so as to implement aspects of the techniques described here. The computing means or resources may notably be distributed (“cloud computing”), possibly with or using peer-to-peer and/or virtualization technologies. The software code may be run on any suitable processor (for example a microprocessor) or processor core or set of processors, whether these are provided in a single computing device or distributed between several computing devices (for example such as potentially accessible in the surroundings of the device). Security technologies (crypto-processors, possibly biometric authentication, encryption, chip card, etc.) may be used.

In some embodiments, the various steps of the method may be implemented wholly or partly on the FMS and/or on one or more EFB (electronic flight bags) and/or tablets and/or airline or mission computers.

1. A method for managing flight data of an aircraft, implemented in a system comprising an avionic system and a non-avionic system, comprising the steps of:
determining flight data in the non-avionic system;
storing said data in a storage space;
determining corresponding flight data in the avionic system; and
comparing the data determined by the avionic system and by the nonavionic system according to a predefined time pattern.

2. The method according to claim 1, the avionic storage space being implemented in the avionic system.

3. The method according to claim 1, the avionic storage space being implemented in a reliable non-avionic system, the physical fault rate and the logic verification of which are respectively lower and higher than those of a non-avionic type system.

4. The method according to claim 1, further comprising the steps of:
detecting the presence of predefined critical data in the data determined by the avionic system and by the non-avionic system;
comparing these critical data; and
displaying the critical data that differ via the human machine interface.

5. The method according to claim 1, further comprising the step of determining risks associated with the differences between the compared data.

6. The method according to claim 1, further comprising the step of displaying all or some of the differences between the compared data and/or the risks associated with the differences via a human-machine interface.

7. The method according to claim 1, further comprising the step of modifying all or some of the determined data in the non-avionic system.

8. The method according to claim 1, the predefined time pattern comprising predefined time intervals, comprising instants in time and durations, for comparing and/or modifying the data.

9. The method according claim 1, further comprising the step of receiving an authorization to insert and/or to activate the potentially modified data determined by the non-avionic system into/in the avionics system.

10. The method according to claim 1, the storage space being secured by one or more mechanisms selected from the mechanisms comprising encryption of the data, checking the integrity of the data or authentication mechanisms.

11. The method according to claim 1, one or more steps being triggered depending on the flight context.

12. A computer program product, said computer program product comprising code instructions allowing the steps of the method according to claim 1 to be carried out, when said program is executed on a computer.

13. A system comprising means for implementing the steps of the method according to claim 1.

14. The system according to claim 13, the avionic system comprising a flight management system FMS and the non-avionic system comprising an electronic flight bag EFB or a non-avionic human-machine interface.

15. The system according to claim 13, the avionic system being a master system and the non-avionic system being a slave system slaved to the master system.
